(19) United States
(12) Patent Application Publication
(10) Pub. No.: US 2019/0156293 A1
(43) Pub. Date: May 23, 2019

(54) USER LOCATION AND ACTIVITY BASED SMART REMINDERS

(71) Applicant: Qualcomm Incorporated, San Diego, CA (US)

(72) Inventors: Akash Kumar, Hyderabad (IN); Ankita, Hyderabad (IN); Hargovind Prassad Bansal, Hyderabad (IN)

(21) Appl. No.: 15/816,194

(22) Filed: Nov. 17, 2017

(51) Int. Cl. G06Q 10/10; G06F 17/27

(52) U.S. Cl. CPC G06Q 10/1095; H04L 67/18; G06F 17/2765

(57) ABSTRACT

In one aspect, an apparatus and method for detecting conflicts between events is provided. In one example, a potential event from content of an active ongoing conversation associated with a user and one or more existing events associated with the user may be identified and compared to determine if a conflict exists between the potential event and at least one of the one or more existing events.

### BACKGROUND

### Field

The present disclosure relates generally to setting up meetings, and more particularly, to managing meeting conflicts based on ongoing conversations.

### Background

As the use of mobile smart devices becomes more prevalent, users rely heavily on mobile phone applications to manage day to day activities. One widely used functionality is to manage the events and activities of the day using calendar and reminder applications that keep track of events that the user needs to get to on a daily basis. Current calendar and/or reminder applications are configured to record information regarding events the user needs to attend or be reminded of, and further provide a mechanism for the user to manage their schedule to avoid missing appointments due to conflicts or other issues.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In aspects of the disclosure, a method, a computer-readable medium, and an apparatus for detecting conflicts between events are provided. In various embodiments, the method may include identifying a potential event from content of an active ongoing conversation associated with a user, identifying one or more existing events associated with the user, comparing the potential event and the one or more existing events and determining that a conflict exists between the potential event and at least one of the one or more existing events based on the comparing. In various embodiments, the comparing may include identifying first information regarding the potential event, identifying second information regarding at least one of the one or more existing event and comparing the first information to second information for at least one of the one or more existing event to determine if a conflict exists. In some examples, conflict exists if at least a portion of the first information overlaps at least a portion of the second information. In some examples, the first information and the second information comprise one or more of an event time, event location, and event participants.

In various embodiments, the method may further include receiving an indication of the active ongoing conversation, wherein the identifying occurs in response to receiving the indication. In some examples, the one or more existing events include one or more events stored at a scheduling application associated with the user. In some examples, the one or more existing events include one or more events being discussed in one or more other conversations associated with the user.

In various embodiments, the active conversation may include one or more conversations associated with the user. In some examples, the active conversation includes a conversation currently occurring at one or more user devices associated with the user. In some examples, the active conversation includes one or more of a phone call, an email message, a chat conversation or a text conversation.

In various embodiments, the method may further include providing a notification of the conflict for display to the user. In various embodiments, the notification is provided for display while the active conversation is still active. In some embodiments, the method may further include determining one or more alternatives that reduce the conflict in response to determining that the conflict exists. In some embodiments, the method may further include providing the one or more alternatives for display to the user while the conversation is still active.

In various embodiments, identifying the potential event may include retrieving content of the ongoing conversation, analyzing the content and identifying one or more key terms or phrases associated with an event based on the content.

In several embodiments, an apparatus for detecting conflicts between events is provided and may include a memory and at least one processor coupled to the memory. In some examples, the at least one processor is configured to identify a potential event from content of an active ongoing conversation associated with a user, identify one or more existing events associated with the user, compare the potential event and the one or more existing events and determine that a conflict exists between the potential event and at least one of the one or more existing events based on the comparing.

In some examples, the apparatus includes a user electronic device associated with the user. In some examples, at least a portion of the active conversation is occurring at the user electronic device. In some examples, the apparatus includes a server at a cloud computing service. In various embodiments, the at least one processor is further configured to receive an indication of the active ongoing conversation, wherein the identifying occurs in response to receiving the indication.

In some examples, the at least one processor is further configured such that the comparing includes identifying first information regarding the potential event, identifying second information regarding at least one of the one or more existing event and comparing the first information to second information for at least one of the one or more existing event to determine if a conflict exists. In some examples, conflict exists if at least a portion of the first information overlaps at least a portion of the second information. In some examples, the first information and the second information include one or more of an event time, event location, and event participants.

In some examples, the one or more existing events may include one or more events stored at a scheduling application associated with the user. In some examples, the one or more existing events may include one or more events being discussed in one or more other conversations associated with the user. In some examples, the active conversation may include one or more separate conversations associated with the user. In some examples, the active conversation includes a conversation currently occurring at one or more user devices associated with the user. In some examples, the active conversation includes one or more of a phone call, an email message, a chat conversation or a text conversation.

In various embodiments, the at least one processor is further configured to provide a notification of the conflict for display to the user.

In various embodiments, one or more processors for detecting conflicts between events may be provided, the one or more processors configured to identify a potential event from content of an active ongoing conversation associated with a user, identify one or more existing events associated with the user, compare the potential event and the one or more existing events and determine that a conflict exists between the potential event and at least one of the one or more existing events based on the comparing. In some examples, the one or more processors include at least one processor at a communication device associated with the user. In various embodiments, at least a portion of the active conversation is occurring at the user communication device. In some examples, the one or more processors include at least one processor at a server. In some examples, the server is associated with a cloud computing service.

In some embodiments, a non-transitory processor-readable medium having stored thereon processor-executable instructions configure to cause a processor of a communication device to perform operations including identifying a potential event from content of an active ongoing conversation associated with a user, identifying one or more existing events associated with the user, comparing the potential event and the one or more existing events and determining that a conflict exists between the potential event and at least one of the one or more existing events based on the comparing.

In some examples, a system for detecting conflicts between events is provided including means for identifying a potential event from content of an active ongoing conversation associated with a user, means for identifying one or more existing events associated with the user, means for comparing the potential event and the one or more existing events and means for determining that a conflict exists between the potential event and at least one of the one or more existing events based on the comparing.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of network environment for a conflict detection system, in accordance with aspects of the disclosure.

FIG. 2 is a block diagram illustrating components of an example mobile computing device configured to detect event conflicts on a device accessible by the user, in accordance with aspects of the disclosure.

FIG. 3 is a block diagram illustrating components of an example conflict resolution application configured to detect event conflicts, in accordance with aspects of the disclosure.

FIG. 4 is a flowchart illustrating an example process for detecting event conflicts for a user at a user device.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of computing systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As the use of mobile smart devices becomes more prevalent, users rely heavily on mobile phone applications to manage day to day activities. One widely used functionality is to manage the events and activities of the day using calendar and reminder applications that keep track of events that the user needs to get to on a daily basis. Current calendar and/or reminder applications are configured to record information regarding events the user needs to attend or be reminded of, and further provide a mechanism for the user to manage their schedule to avoid missing appointments due to conflicts or other issues.

One useful feature of the calendar or reminder applications is the ability to point out when there are conflicts between existing events and new events that the user attempts to enter into the calendar or reminder application. However, while current calendar applications reside side by side with other applications on the user phone, including the applications used to communicate with other users, currently there is not much integration between the calendar application and these applications when it comes to conflict resolution. That is, current calendar applications are not capable of notifying the user before events are entered into the calendar application. This often causes issues for the user as the user is not able to agree upon an acceptable time for a meeting while in an ongoing conversation without checking their calendar application or entering the meeting into the calendar application directly. Therefore, there is a need for a system that can detect conflicts between potential events and scheduled events and provide conflict notifications to a user while the user is engaged in an ongoing conversation without requiring the user to use the calendar application.

In some embodiments, a conflict detection system is provided for identifying event conflicts between a scheduled event such as a meeting, a phone call, an appointment, or other event and potential events using information of the potential event extracted from an active conversation such as a phone call, chat, text message, email or other conversation to provide event conflict detection systems and services. The conflict detection system is facilitated by determining information on a potential event for a user based on an active conversation and/or information on an existing event already recorded in a calendar or reminder application associated with a user. Information regarding a potential event can be obtained, in some instances, using content of one or more active conversations between a user and more or more other users. In some examples, various speech and text recognition mechanisms may be used to identify a potential event being discussed in an active conversation such as a phone call, chat, email, text messages or other similar conversations taking place on a user device. Once a potential event is identified (e.g., using keywords or other triggers), information regarding the potential event may be obtained and may be compared against information regarding a set of scheduled events for the user to identify any conflicts between the potential event and the scheduled events. This information can be used to provide notifications regarding any conflicts to the user.

In various embodiments, the conflict detection system may be implemented by one or more processors. In some examples, the one or more processors may include processor(s) at a user device and/or at one or more remote devices, or servers. In some examples, the one or more processors may be configured to implement a conflict detection method and/or system for identifying a conflict between existing events associated with a user of a user device and a potential event for a user of a user device and may further provide a notification of the conflict, for example at the user device.

In some examples, one or more processors are configured to receive an indication of an active conversation associated with a user. In various embodiments, an active conversation may include a conversation currently occurring at a user device associated with the user. Example active conversations may include, but are not limited to, a phone call, email, text message or chat conversation. In some embodiments, one or more processors may receive an indication that a conversation is occurring at the user device between a user of a user device and at least one other user at one or more other user devices. In some examples, a conversation may be determined to be ongoing for as long as the conversation is occurring at the user device, such as in the example of a phone call. In another example, the conversation may be considered active within a predefined period of time during which there is an indication that the user of the user device or other user device is providing content to the conversation (e.g., the user is drafting the email, a text message or chat, or there is an indication that the other user(s) participating in the conversation are drafting). In another example, the conversation may be considered active for a threshold period of time after content is being provided by a user at the user device or another participant of the conversation. For example, a conversation may be determined active event a threshold amount of time (e.g., one minute or less) after a message has been sent from the user of the user device during a conversation. In various embodiments, the one or more processors may identify several conversations occurring between the user and one or more other users, and may determine that the conversations all relate to the potential event. In such examples, these conversations may be grouped and identified as the active conversation. In some examples, the more or more conversations may be occurring at a single device or across multiple devices associated with the user.

One or more processors may be configured to identify a potential event from the content of the active conversation. In some examples, one or more processors may be configured to employ various text or speech recognition algorithms to identify and analyze the content of the active conversation. The content of the active conversation may be analyzed by one or more processors to identify a potential event. In some examples, keywords, sentences, or other indicators may be associated with an indication that a potential event is being discussed in a conversation. In such embodiments, one or more processors may be configured to identify such keywords, sentences or other indicators to determine that a user at a user device is discussing a potential event in an active conversation.

In response to identifying the potential event one or more processors may identify information regarding the potential event. In some examples, the information regarding the potential event may include, but is not limited to, time (e.g., time of day, and/or date), location, participants, subject, and any other similar information regarding the event.

In various embodiments, one or more processors may access one or more existing events for the user. In some examples, existing events may include events already scheduled in one or more calendars associated with the user. For example, calendars associated with the user may include one or more calendar or reminder applications at a user device associated with the user, and/or calendar or reminder applications associated with a user (e.g., with a user account) at one or more remote servers (e.g., cloud or web services). In some embodiments, in addition to the current active conversation, the user may also be involved in one or more other active conversations. In some examples, the one or more existing events may include one or more potential events being discussed during these other active conversations being carried out by the user. In such embodiments, one or more processors may monitor and identify the events being discussed during the other active conversations (e.g., using similar techniques as discussed here with respect to the potential event). In some embodiments, information regarding the identified existing events may be identified. In some examples, the information regarding the one or more existing events may include, but is not limited to, time (e.g., time of day, and/or date), location, participants, subject, and any other similar information regarding the event.

In various embodiments, the information regarding the potential event may be compared with the information regarding the one or more existing events, by one or more processors. For example, one or more processors may compare the time, location, participants and/or other information regarding the potential event with the time, location and participants and/or other information regarding the one or more existing events. Based on the comparison, one or more processors may determine if a conflict exists between the potential event and at least one of the one or more existing events. In some examples, a conflict may be detected if there is a conflict with the time of the potential event and one or more existing events. In other embodiments, a conflict may exist if there is an overlap between the suggested location of the potential event and at least one existing event. In other examples, a conflict may exist if there is at least some overlap between the participants of the potential event and one or more existing events.

If such conflict exists, a notification may be provided to the user at a user device (e.g., a user device at which the active conversation is occurring). In one example, the notification may be provided using an alarm or other indication displayed to the user. For example, an auditory, visual or haptic notification may be generated in response to the determination that a conflict exists and may be provided at the user device. In some examples, the notification may be provided in the message display or as part of the active conversation. In some examples, the notification is provided while the active conversation is still active. In various embodiments, the conflict detection system enables detection of a conflict and/or notification of the conflict without requiring the event to be entered into a calendar or reminder application and thus allows for detecting conflicts while the user is participating in an active conversation. In some examples, the conflict detection occurs without requiring any further activity from the user. In various embodiments, the conflict detection and/or the generation of the notification are performed by one or more processors based on the content of an active conversation and without requiring further activity by the user (e.g., the user checking their existing events or entering the event into a calendar or reminder application or other application).

In the following detailed description, references are made to the accompanying drawings that form a part hereof, and which are shown by way of illustration of specific embodiments or examples. Referring now to the drawings, in which like numerals represent like elements throughout the several figures, aspects of a system for providing smart reminders are provided.

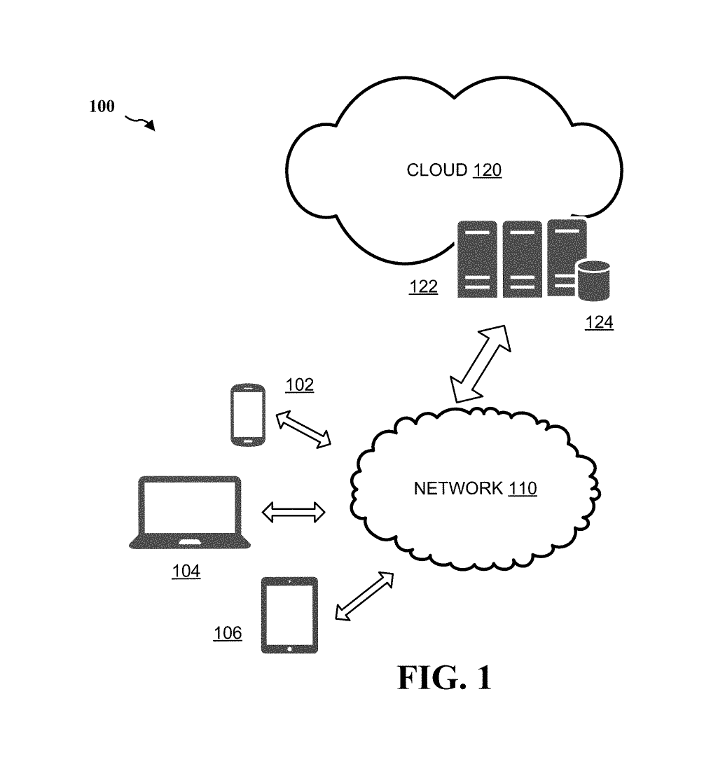

FIG. 1 is a diagram illustrating an example of network environment 100 for implement various embodiments of a conflict detection system, in accordance with aspects of the disclosure. The network environment 100 of FIG. 1 shows various types of user devices 102, 104 and 106 that can be used in conjunction with the conflict resolution system and/or service. The user devices 102, 104 and 106 may be communicatively coupled to one another, to one or more other user devices and/or to a cloud computing environment 110, through a network 110.

Example user devices may include, for example, a smart phone 102, a laptop 104 and/or a tablet computer 106. Other user devices, not depicted in FIG. 1, may also be present in network 110. As used herein, the term “user device”, “mobile communication device” or “communication device” refers to any one or all of cellular telephones, smart phones, smart watches, personal or mobile multi-media players, personal data assistants, laptop computers, tablet computers, smart books, palm-top computers, wireless electronic mail receivers, multimedia Internet-enabled cellular telephones, wireless gaming controllers, and similar personal electronic devices that includes a programmable processor, memory, and circuitry for connecting to one or more other communication devices, networks, base stations, and other intermediary communication nodes. Various embodiments may be useful in mobile communication devices, such as smart phones, and so such devices are referred to in the descriptions of various embodiments.

Network 110 may include one or more networks for facilitating communication among user devices (e.g., user devices 102, 104, 106) and/or one or more remote servers (e.g., cloud 120). For example, network 110 may include one or more mobile networks. In some examples, each mobile network may include a plurality of cellular base stations. A first user device (e.g., user device 102, 104, 106) may be in communication with a first mobile network through a cellular connection to a first base station. The cellular connections may be made through two-way wireless communication links, such as Third Generation (3G), Fourth Generation (4G), Long Term Evolution (LTE), Time Division Multiple Access (TDMA), Code Division Multiple Access (CDMA), Wideband CDMA (WCDMA), Global System for Mobile Communications (GSM), and Universal Mobile Telecommunications Systems (UMTS), and other mobile telephony communication technologies.

One or more user devices may also be able to communicate with the network 110 through a non-cellular connection, such as a WiFi connection, an Ethernet connection, optical fiber connection, cable or telephone line connection, satellite connection, or other wired or wireless local area network (LAN) or wide area network (WAN) connections. In addition, the user may use a user device (e.g., user devices 102, 104, 106) connected through a wired connection to the network 110. The wired connection may be accomplished, using various technologies, including using a cable modem, DSL adaptor, Wi-Fi adaptor, or any other technology for accomplishing an Internet data connection. The smart phone 102, laptop 104, and tablet computer 106 are only some of the types of devices that can be used in accessing the conflict detection system. Other device types, such as wearable devices including a smartwatch, a health monitoring and activity tracking device, may also be connected to the communication network 110 directly or indirectly (through other electronic devices) and be part of the smart reminder system.

In some embodiments, a user device (e.g., user devices 102, 104, 106) may optionally establish a wireless connection with a peripheral device used in connection with the first communication device 110. For example, the mobile communication device 110 may communicate over a Bluetooth® link with a Bluetooth-enabled personal computing device (e.g., a “smart watch”).

The user devices may interact with the cloud computing environment 120. The cloud computing environment may include servers 122 and storage devices 124. The servers 122 may include a variety of server technologies, including distributed processing systems, blade servers, and parallel processing servers. The servers access storage devices 124, which may include various types of solid state memory and hard disk storage systems. The storage devices 124 may be used to store data for various applications.

In some implementations, the user devices may or may not access the cloud computing environment 120 to provide conflict detection services to the user on the device(s). In some examples, all or portions of the conflict detection system may be executed by one or more processors at the user device(s) and data may be stored in memory at the user device(s). In some examples, all or portions of the conflict detection system may be implemented at the cloud computing environment 120 (e.g. using one or more servers 122) and data may be stored in storage devices 124 at the cloud computing environment. Other configurations are possible for performing the processes disclosed herein including using a variety of computer devices.

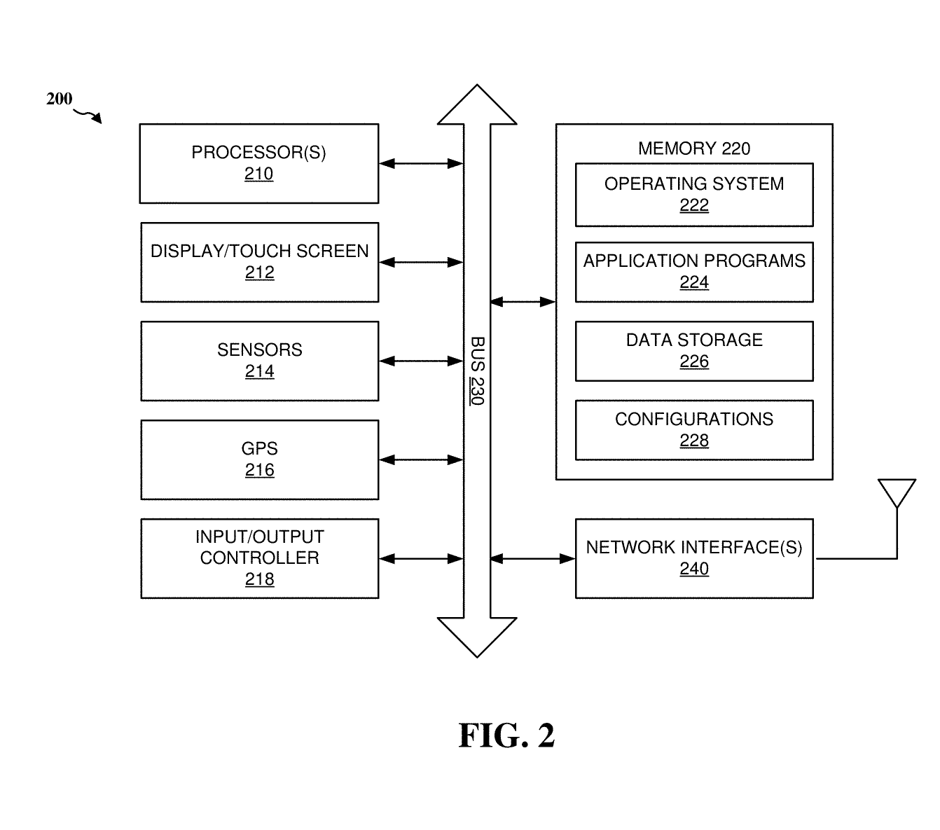

FIG. 2 is a block diagram illustrating components of an example electronic device 200 configured to provide conflict detection services to a user on a device accessible by the user, in accordance with aspects of the disclosure. The example electronic device may include the smart phone 102, the laptop 104, the tablet computer 106, or some other type of device, such as a wearable device. The example electronic device may also include servers 122 and/or storage devices 124. Other components or architectures may also be used to execute the smart reminder applications presented herein.

In one configuration, the example electronic device may be a user equipment (UE). Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, or any other similar functioning device. The UE may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The computing device architecture shown in FIG. 2 may include one or more processors 210, a memory 220, which may include volatile storage, such as random access memory (“RAM”), and non-volatile storage, such as read-only memory (“ROM”), and a system bus 230 that couples the memory 220 and other components to the one or more processors 210. The memory 220 may further stores an operating system 222, application programs 224, such as, but not limited to, calendar applications, reminder applications, communication applications, web browsers, and/or conflict detection application, a data repository 226 for storing application data, such as event information and/or conflict notifications, and device configurations 228 for configuring various functionalities of the computing device. Other application programs and data may also be stored in memory 220. The memory 220 may be connected to the one or more processors 210 through a controller (not shown in FIG. 2), which in turn is connected to the system bus 230.

The electronic device 200 may connect to the network through one or more network interfaces 240, which are also coupled to the bus 230. The network interfaces 240 may include a radio interface for wireless local area network (LAN) based on IEEE 802.11 standards. It should be appreciated that the one or more network interfaces may also utilize a variety of wired and/or wireless technologies to connect to other types of networks and remote computer systems.

An input/output controller 218 may be used for receiving and processing input from a number of devices, such as keys, buttons, stylus, and interfaces for connecting a keyboard and/or a mouse (not shown in FIG. 2). Similarly, the input/output controller 218 may provide output to a display screen or some other type of output device. In some implementations, the computing device may incorporate a touch screen display 212, which may display information and receive input, including text, commands, and control information.

The electronic device 200 may include one or more sensors 214 for capturing user activity information, biometric information, images and videos, among other information. The one or more sensors may include motion sensors, such as an accelerometer for measuring acceleration, a gyroscope for measuring orientation, or a combination thereof. Alternatively or in addition, the one or more sensors may include biometric sensors for obtaining the user's biometric information, such as heart rate, blood pressure, and skin colorization. The electronic device 200 may also include one or more cameras, such as photo cameras or video cameras, for voice/video messaging, voice/video conferencing, and/or recording images, voice information or videos relating to the user's activities.

The electronic device 200 may also incorporate a GPS module 216 capable of receiving GPS signals and determining a location of the electronic device 200. The electronic device 200 may also incorporate an audio interface, such as a microphone, a speaker, and an earphone port, for effecting voice communications and voice control functions. The electronic device 200 may also incorporate one or more visual indicators, such as LEDs.

It should be appreciated that the software components described herein may, when loaded into the one or more processors 210 and executed, transform the processors 210 and the overall electronic device 200 from a general-purpose computing system into a special-purpose computing system customized to facilitate the functionality presented herein. More specifically, the processors 210 may operate as a finite-state machine, in response to executable instructions contained within the software modules disclosed herein. These computer-executable instructions may transition the processors 210 between states.

It also should be appreciated that the electronic device 200 may include other types of computing devices, including server computers, desktop computers, embedded computer systems, e-book readers, set-top boxes, personal digital assistants, and other types of computing devices operative to provide location and activity based smart reminder on a user device in accordance with aspects of the disclosure herein. The electronic device 200 may not include all of the components shown in FIG. 2, may include other components that are not explicitly shown in FIG. 2, or may utilize an architecture different than that shown in FIG. 2.

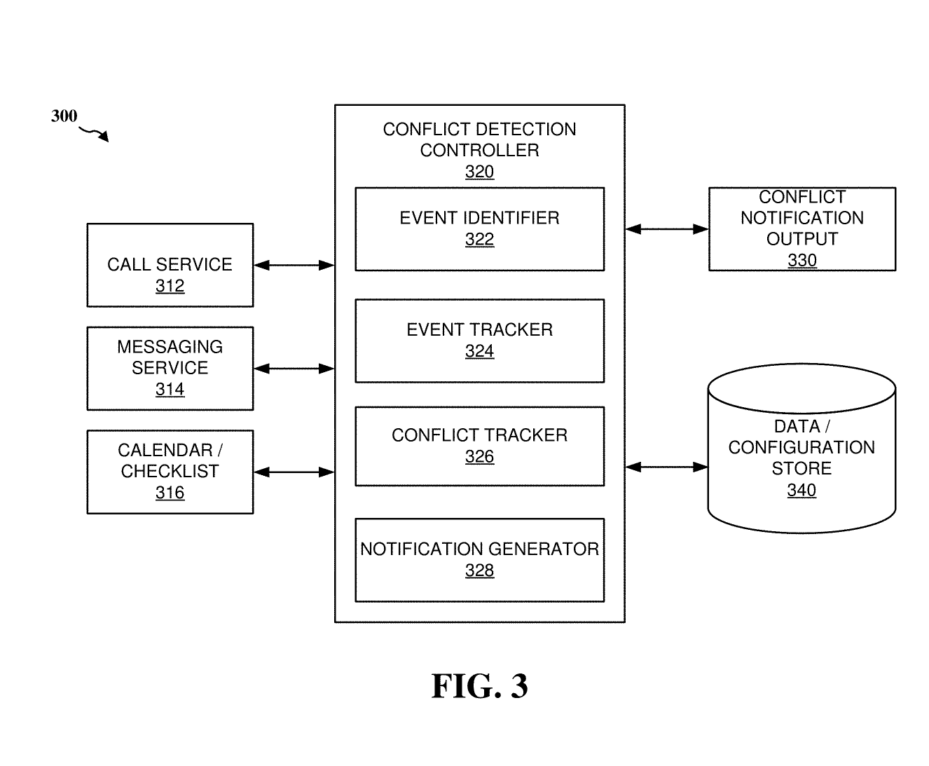

FIG. 3 is a block diagram illustrating components of an example conflict detection application 300 configured to detect one or more event conflicts and/or provide conflict notifications, in accordance with aspects of the disclosure. In some implementations, the conflict detection application 300 may include components such as a calendar component and/or a communication component, among other components. In some implementations, the conflict detection application 300 may be a standalone application or may be incorporated into other applications, such as a calendaring application or a communication application.

In the example shown in FIG. 3, the smart reminder application 300 may include a conflict detection controller 320, a data/configuration store 340 to store event data and system settings, at least one conflict notification output 330 and interfaces to other system or software modules, such as call service(s) 312, messaging service(s) 314, and/or calendar/checklist application(s) 316. The interfaces may be implemented using calls to an application program interface (API) of the corresponding system or software modules. Furthermore, the reminder controller 320 may include an event identifier 322, an event tracker 324, a conflict tracker 326, and a notification generator 328. The conflict tracker 326 may use information determined or obtained by the conversation identifier 322, the event detector 324, to identify a conflict between one or more existing events and a potential event. The notification generator may use the determinations of the conflict tracker 326 to determine when notifications regarding event conflicts should be generated. These components are described in more detail below.

In some implementations, the conflict tracker 326 can compare information regarding a potential event such as a meeting, an appointment, or an activity being discussed during an active conversation using one or more call service(s) 312 or messaging service(s) 314 identified by the event identifier 322 with information regarding existing events, such as a meeting, an appointment, or an activity stored by the calendar/checklist application 316 or identified by event identifier 322 as part of one or more other active conversations using one or more call service(s) 312 or messaging service(s) 314 and stored in data/configuration store 340 to identify a conflict between the potential event and one or more existing events based on the information. For example, information on a meeting may include the participant(s), the meeting location, and the time and date of the meeting. The notification generator 328 may use the results of the comparison to generate a notification to a user at a user device.

Although the above-described embodiment has been described in terms of separate modules or components, in other embodiments the functions of the various modules or components may be performed by other modules and/or combined into fewer modules. In still other embodiments, some of the functions performed by the described modules may be separated further into more modules. In various implementations, various modules or components may be implemented at one or more user devices (e.g., user devices 102, 104, 106) and/or at one or more remote services (e.g., cloud computing environment 120).

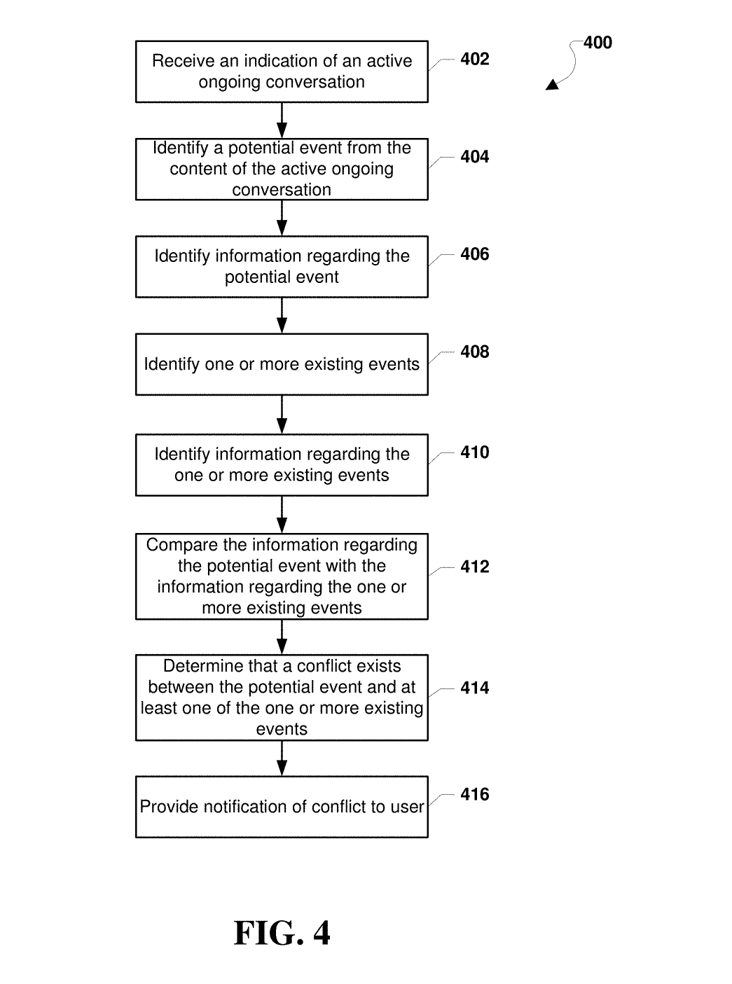

FIG. 4 is a flowchart illustrating an example process 400 for detecting an event conflict for a user, in accordance with aspects of the disclosure. The process 400 may be performed in any suitable computing environment, such as the electronic device 200 (FIG. 2), to implement smart reminder application 300 (FIG. 3). Therefore, the description of the process 400 may refer to at least one of the components of FIGS. 2 and 3. However, any such reference to components of FIGS. 2 and 3 is for descriptive purposes only, and it is to be understood that the implementations of FIGS. 2 and 3 are a non-limiting environment for the example process 400.

In block 402, one or more processors may receive an indication of an active conversation associated with a user. In various embodiments, an active conversation may include a conversation currently occurring at a user device associated with the user. Example active conversations may include, but are not limited to, a phone call, email, text message or chat conversation. In some embodiments, one or more processors may receive an indication that a conversation is occurring at the user device between a user of a user device and at least one other user at one or more other user devices. In some examples, a conversation may be determined to be ongoing for as long as the conversation is occurring at the user device, such as in the example of a phone call. In another example, the conversation may be considered active within a predefined period of time during which there is an indication that the user of the user device or other user device is providing content to the conversation (e.g., the user is drafting the email, a text message or chat, or there is an indication that the other user(s) participating in the conversation are drafting). In another example, the conversation may be considered active for a threshold period of time after content is being provided by a user at the user device or another participant of the conversation. For example, a conversation may be determined active event a threshold amount of time (e.g., one minute or less) after a message has been sent from the user of the user device during a conversation. In various embodiments, the one or more processors may identify several conversations occurring between the user and one or more other users, and may determine that the conversations all relate to the potential event. In such examples, these conversations may be grouped and identified as the active conversation. In some examples, the more or more conversations may be occurring at a single device or across multiple devices associated with the user.

In block 404, one or more processors may identify a potential event from the content of the active conversation. In some examples, one or more processors may be configured to employ various text or speech recognition algorithms to identify and analyze the content of the active conversation. The content of the active conversation may be analyzed by one or more processors to identify a potential event. In some examples, keywords, sentences, or other indicators may be associated with an indication that a potential event is being discussed in a conversation. In such embodiments, one or more processors may be configured to identify such keywords, sentences or other indicators to determine that a user at a user device is discussing a potential event in an active conversation.

In block 406, one or more processors may identify information regarding the potential event. In some examples, the information regarding the potential event may include, but is not limited to, time (e.g., time of day, and/or date), location, participants, subject, and any other similar information regarding the event.

In block 408, one or more processors may access one or more existing events for the user. In some examples, existing events may include events already scheduled in one or more calendars associated with the user. For example, calendars associated with the user may include one or more calendar or reminder applications at a user device associated with the user, and/or calendar or reminder applications associated with a user (e.g., with a user account) at one or more remote servers (e.g., cloud or web services). In some embodiments, in addition to the current active conversation, the user may also be involved in one or more other active conversations. In some examples, the one or more existing events may include one or more potential events being discussed during these other active conversations being carried out by the user. In such embodiments, one or more processors may monitor and identify the events being discussed during the other active conversations (e.g., using similar techniques as discussed here with respect to the potential event). In block 410, information regarding the identified existing events may be identified. In some examples, the information regarding the one or more existing events may include, but is not limited to, time (e.g., time of day, and/or date), location, participants, subject, and any other similar information regarding the event.

In block 412, the information regarding the potential event may be compared with the information regarding the one or more existing events, by one or more processors. For example, one or more processors may compare the time, location, participants and/or other information regarding the potential event with the time, location and participants and/or other information regarding the one or more existing events. In block 414, one or more processors may determine that a conflict exists between the potential event and at least one of the one or more existing events. In various embodiments, the determination may be based on the comparison in ste 412. In some examples, a conflict may be detected if there is a conflict with the time of the potential event and one or more existing events. In other embodiments, a conflict may exist if there is an overlap between the suggested location of the potential event and at least one existing event. In other examples, a conflict may exist if there is at least some overlap between the participants of the potential event and one or more existing events.

In block 416, a notification may be provided to the user at a user device when it is determined that such conflict exists (e.g., a user device at which the active conversation is occurring). In one example, the notification may be provided using an alarm or other indication displayed to the user. For example, an auditory, visual or haptic notification may be generated in response to the determination that a conflict exists and may be provided at the user device. In some examples, the notification may be provided in the message display or as part of the active conversation. In some examples, the notification is provided while the active conversation is still active. In some examples, in addition or as part of the notification, one or more alternative times, venues, or other alternatives that would provide none or less conflicts may be provided to the user. In some examples, in response to determining the conflict exists, one or more reasons for the conflict may be identified and one or more suggested alternatives that reduce or remove such conflicts may be determined. In various embodiments, such suggestions are provided to the user in addition to, in lieu of, or as part of the notification.

In various embodiments, the conflict detection system enables detection of a conflict and/or notification of the conflict without requiring the event to be entered into a calendar or reminder application and thus allows for detecting conflicts while the user is participating in an active conversation. In some examples, the conflict detection occurs without requiring any further activity from the user. In various embodiments, the conflict detection and/or the generation of the notification are performed by one or more processors based on the content of an active conversation and without requiring further activity by the user (e.g., the user checking their existing events or entering the event into a calendar or reminder application or other application).

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of detecting conflicts between events, comprising:
identifying a potential event from content of an active ongoing conversation associated with a user;
identifying one or more existing events associated with the user;
comparing the potential event and the one or more existing events; and
determining that a conflict exists between the potential event and at least one of the one or more existing events based on the comparing.

2. The method of claim 1, further comprising receiving an indication of the active ongoing conversation, wherein the identifying occurs in response to receiving the indication.

3. The method of claim 1, wherein the comparing comprises:
identifying first information regarding the potential event;
identifying second information regarding at least one of the one or more existing event; and
comparing the first information to second information for at least one of the one or more existing event to determine if a conflict exists.

4. The method of claim 3, wherein conflict exists if at least a portion of the first information overlaps at least a portion of the second information.

5. The method of claim 3, wherein the first information and the second information comprise one or more of an event time, event location, and event participants.

6. The method of claim 1, wherein the one or more existing events comprise one or more events stored at a scheduling application associated with the user.

7. The method of claim 1, wherein the one or more existing events comprise one or more events being discussed in one or more other conversations associated with the user.

8. The method of claim 1, wherein the active conversation comprises one or more conversations associated with the user.

9. The method of claim 1, wherein the active conversation comprises a conversation currently occurring at one or more user devices associated with the user.

10. The method of claim 1, wherein the active conversation comprises one or more of a phone call, an email message, a chat conversation or a text conversation.

11. The method of claim 1, further comprising providing a notification of the conflict for display to the user.

12. The method of claim 11, wherein the notification is provided for display while the active conversation is still active.

13. The method of claim 1, further comprising determining one or more alternatives that reduce the conflict in response to determining that the conflict exists.

14. The method of claim 13, further comprising providing the one or more alternatives for display to the user while the conversation is still active.

15. The method of claim 1, wherein the identifying the potential event comprises:
retrieving content of the ongoing conversation;
analyzing the content; and
identifying one or more key terms or phrases associated with an event based on the content.

16. An apparatus for detecting conflicts between events, comprising:
a memory; and
at least one processor coupled to the memory and configured to:
identify a potential event from content of an active ongoing conversation associated with a user;
identify one or more existing events associated with the user;
compare the potential event and the one or more existing events; and
determine that a conflict exists between the potential event and at least one of the one or more existing events based on the comparing.

17. The apparatus of claim 16, wherein the apparatus is a user electronic device associated with the user.

18. The apparatus of claim 17, wherein at least a portion of the active conversation is occurring at the user electronic device.

19. The apparatus of claim 16, wherein the apparatus is a server at a cloud computing service.

20. The apparatus of claim 16, wherein the at least one processor is further configured to receive an indication of the active ongoing conversation, wherein the identifying occurs in response to receiving the indication.

21. The apparatus of claim 16, wherein the comparing comprises:
identifying first information regarding the potential event;
identifying second information regarding at least one of the one or more existing event; and
comparing the first information to second information for at least one of the one or more existing event to determine if a conflict exists.

22. The apparatus of claim 21, wherein conflict exists if at least a portion of the first information overlaps at least a portion of the second information.

23. The apparatus of claim 21, wherein the first information and the second information comprise one or more of an event time, event location, and event participants.

24. The apparatus of claim 16, wherein the one or more existing events comprise one or more events stored at a scheduling application associated with the user.

25. The apparatus of claim 16, wherein the one or more existing events comprise one or more events being discussed in one or more other conversations associated with the user.

26. The apparatus of claim 16, wherein the active conversation comprises one or more separate conversations associated with the user.

27. The apparatus of claim 16, wherein the active conversation comprises a conversation currently occurring at one or more user devices associated with the user.

28. The apparatus of claim 16, wherein the active conversation comprises one or more of a phone call, an email message, a chat conversation or a text conversation.

29. The apparatus of claim 16, wherein the at least one processor is further configured to provide a notification of the conflict for display to the user.

30. One or more processors for detecting conflicts between events, the one or more processors configured to:
identify a potential event from content of an active ongoing conversation associated with a user;
identify one or more existing events associated with the user;
compare the potential event and the one or more existing events; and
determine that a conflict exists between the potential event and at least one of the one or more existing events based on the comparing.

31. The one or more processors of claim 30, wherein the one or more processors comprise at least one processor at a communication device associated with the user.

32. The one or more processors of claim 30, wherein at least a portion of the active conversation is occurring at the user communication device.

33. The one or more processors of claim 30, wherein the one or more processors comprise at least one processor at a server.

34. The one or more processors of claim 33, wherein the server is associated with a cloud computing service.

35. A non-transitory processor-readable medium having stored thereon processor-executable instructions configure to cause a processor of a communication device to perform operations comprising:
identifying a potential event from content of an active ongoing conversation associated with a user;
identifying one or more existing events associated with the user;
comparing the potential event and the one or more existing events; and
determining that a conflict exists between the potential event and at least one of the one or more existing events based on the comparing.

36. A system for detecting conflicts between events, comprising:
means for identifying a potential event from content of an active ongoing conversation associated with a user;
means for identifying one or more existing events associated with the user;
means for comparing the potential event and the one or more existing events; and
means for determining that a conflict exists between the potential event and at least one of the one or more existing events based on the comparing.
